(19) United States
(12) Patent Application Publication
(10) Pub. No.: US 2005/0163065 A1
(43) Pub. Date: Jul. 28, 2005

(54) Telecommunication system with message based control

(75) Inventor: David Caldecott Yule, Taipel (TW)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electroics N.V.

(21) Appl. No.: 10/513,275

(22) PCT Filed: Apr. 11, 2003
(86) PCT No.: PCT/IB03/01537

(30) Foreign Application Priority Data
May 7, 2002 (EP) 02076831.3

(51) Int. Cl. H04J 1/10; H04J 3/08; H04B 7/14

(52) U.S. Cl. 370/315

(57) ABSTRACT

Telecommunication systems comprising terminals (1) and network-units (10) for exchanging messages via messaging servers (11) for client-to-client information are provided with detectors (7,14) for detecting control instructions and generators (6,15) for generating control instructions. The messages are provided with these control instructions for controlling interactions between terminals (1) and network-units (10). As a result, messaging servers (11) can now control different kinds of interactions in as well as across different kinds of networks. Said messages further comprise origin and destination identifications. Said control instructions comprise authentication instructions for authenticating said interaction, capability instructions or set up instruction for setting up a communication. Said messages can be in the form of XML messages. Bridging servers (30) bridge the gap between parties which can communicate with messaging servers (11) and parties which cannot.

The invention relates to a telecommunication system comprising a terminal and a network-unit, which terminal comprises a transceiver for transceiving messages and which network-unit comprises a transceiver for transceiving said messages and comprises a messaging server for serving said messages.

The invention also relates to a terminal for use in a telecommunication system comprising said terminal and a network-unit, which terminal comprises a transceiver for transceiving messages and which network-unit comprises a transceiver for transceiving said messages and comprises a messaging server for serving said messages, and to a network-unit for use in a telecommunication system comprising a terminal and said network-unit, which terminal comprises a transceiver for transceiving messages and which network-unit comprises a transceiver for transceiving said messages and comprises a messaging server for serving said messages, and to a messaging server for use in a telecommunication system comprising a terminal and a network-unit, which terminal comprises a transceiver for transceiving messages and which network-unit comprises a transceiver for transceiving said messages and comprises said messaging server for serving said messages, and to a method for use in a telecommunication system and comprising the steps of transceiving messages in a terminal and of transceiving said messages in a network-unit and of serving said messages in a messaging server in said network-unit, and to a processor program product for use in a network-unit and comprising the function of transceiving messages in said network-unit and of serving said messages in a messaging server in said network-unit, and to a processor program product for use in a terminal and comprising the function of transceiving messages in said terminal.

Such a telecommunication system is for example a GSM system or a UMTS system or a wireless LAN system or a wired network etc., with said terminal for example being a GSM terminal or a UMTS terminal or a wireless LAN terminal or a pc etc., and with said network-unit for example being a GSM base station or a UMTS node or a wireless LAN unit or a switch of an Access Provider and/or of a Service Provider etc., and with said messaging server being a server for serving said messages like receiving a message from a first client and forwarding it to a second client. Said message is for example a Short Message Service message or SMS message allowing the exchange of data between clients. These messages are just for client-to-client information.

A prior art telecommunication system is known from WO 01/56308, which discloses a wireless network coupled to wireless terminals and a fixed network coupled to fixed terminals and which bridges the gap between the instant messaging services of fixed networks and wireless terminals. According to this prior art, messages are generated to inform (fixed or wireless) clients that other (wireless or fixed) clients can be reached (due to wireless terminals being turned on or fixed terminals being on-line). Although according to this prior art messages are exchanged between terminal and network (and not between two terminals), these messages are just for client-to-client information, and inform a first client that a second client can be reached.

The known telecommunication system is disadvantageous, inter alia, due to not being integrated well: said messages are being used for information purposes, with the control of the network (GSM or UMTS or wireless LAN or wired network etc.) being realized completely separately from said messages.

It is an object of the invention, inter alia, of providing a telecommunication system as defined in the preamble which is more integrated.

The telecommunication system according to the invention is characterized in that at least one message comprises at least a part of at least one control instruction for controlling at least one interaction between terminal and network-unit, with said terminal and said messaging server each comprising a detector for detecting control instructions and a generator for generating control instructions.

By providing at least one message with at least a part of at least one control instruction for controlling at least one interaction between terminal and network-unit, and by providing said terminal and said messaging server each with a detector for detecting control instructions and a generator for generating control instructions, interactions between terminal and network-unit can now be controlled via the messaging server. Contrary to prior art, where messaging servers were used for client-to-client information and where network control was realized separately, the telecommunication system according to the invention has combined both options. As a result, the same messaging infrastructure may be used for controlling different kinds of interactions in and/or across different kinds of networks.

The invention is based upon an insight, inter alia, that messaging infrastructures can be used for more than one purpose, and is based upon a basic idea, inter alia, that messages can be provided with control instructions instead of and/or in addition to client-to-client information.

The invention solves the problem, inter alia, of providing a telecommunication system which is more integrated, and is advantageous, inter alia, in that the same message comprising the same control instructions can be the same for the same interactions in and/or across different kinds of networks.

A first embodiment of the telecommunication system according to the invention as defined in claim 2 is advantageous in that said message further comprises an origin identification and/or a destination identification.

Said identifications defining a client and/or a terminal and/or a network-unit and/or a messaging server allow different clients to use different terminals and different messaging servers and to enter different networks via different network-units. An origin identification defines a transmitting party (client or terminal or network-unit or messaging server etc.) and a destination identification defines a receiving party (client or terminal or network-unit or messaging server etc.).

A second embodiment of the telecommunication system according to the invention as defined in claim 3 is advantageous in that control instructions comprise authentication instructions for authenticating said interaction.

Said authentication instructions allow an authentication of said interaction, for example for billing purposes. Generally, at least two authentication instructions will be exchanged: a first authentication instruction via a first message from transmitting party to receiving party, and a second authentication instruction via a second (response) message vice versa, after which at least one of said parties will decide whether to continue of not.

A third embodiment of the telecommunication system according to the invention as defined in claim 4 is advantageous in that control instructions comprise capability instructions defining capabilities.

Said capability instructions define the kinds of interactions possible, like for example a GSM communication, a UMTS communication, a wireless LAN communication, an IP communication, a Voice over IP or VoIP communication, an MPEG-2 or MPEG-4 communication, voice mail, conference call etc. Generally, at least two capability instructions will be exchanged: a first capability instruction via a first message from transmitting party to receiving party to inform said receiving party of the capabilities of said transmitting party, and a second capability instruction via a second (response) message vice versa, after which at least one of said parties will decide which communication will take place.

A fourth embodiment of the telecommunication system according to the invention as defined in claim 5 is advantageous in that a control instructions comprises a set up instruction for setting up a communication.

Said set up instruction allows the setting up of an interaction in the form of a communication between two parties being clients and/or terminals. Generally, said set up instruction will comprise an identification of a client and/or of a terminal to be reached. Generally, but not exclusively, after said communication has been established, the messaging server will no longer be involved in this communication.

So, a user may interact with a messaging server via all kinds of terminals and all kinds of links and all kinds of network-units, for registration, authentication, capability negotiation, getting information etc., for setting up communications with other users via all kinds of terminals and all kinds of links and all kinds of network-units independently of said other users using the same messaging infrastructure via one or more messaging servers or using a different one or no one at all with a bridging server then being a kind of interface.

A fifth embodiment of the telecommunication system according to the invention as defined in claim 6 is advantageous in that said messages are XML messages.

XML messages originate from an open standard, see for example http://www.w3.org/XML/, and allow the use of multiple servers, with an XML UserID identifying a client as well as his/her home server. But other messages are not to be excluded, like for example messages used in messaging infrastructures of operating system providers and internet providers.

It should be noted that at least one message comprises at least a part of at least one control instruction. One message may comprise more than one control instruction, and may comprise several submessages each comprising a (part of a) control instruction, with said submessages being exchanged subsequently in time (possibly being separated by empty or non-empty time-slots) and/or via frequency division and/or code division etc. Other messages may also comprise (parts of) control instructions, and/or may comprise data like for example client-to-client data like general information.

Embodiments of the terminal according to the invention, of the network-unit according to the invention, of the messaging server according to the invention, of the method according to the invention, of the processor program product according to the invention for use in a network-unit and of the processor program product according to the invention for use in a terminal correspond with the embodiments of the telecommunication system according to the invention.

These and other aspects of the invention will be apparent from and elucidated with reference to the embodiments(s) described hereinafter.

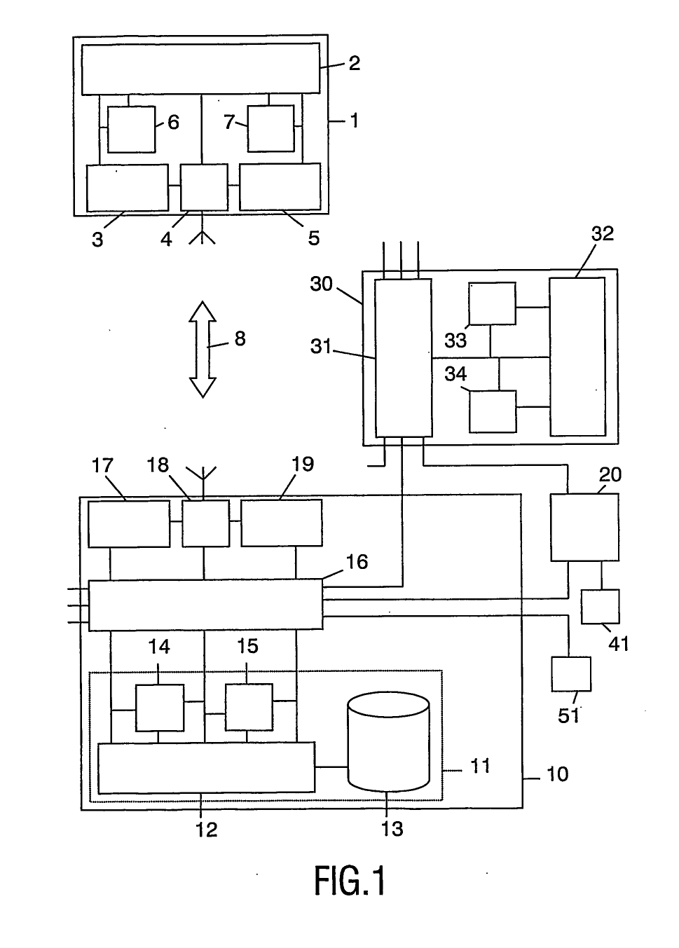

FIG. 1 illustrates in block diagram form a telecommunication system according to the invention comprising a mobile terminal according to the invention and a network-unit according to the invention, the latter comprising a messaging server according to the invention, and

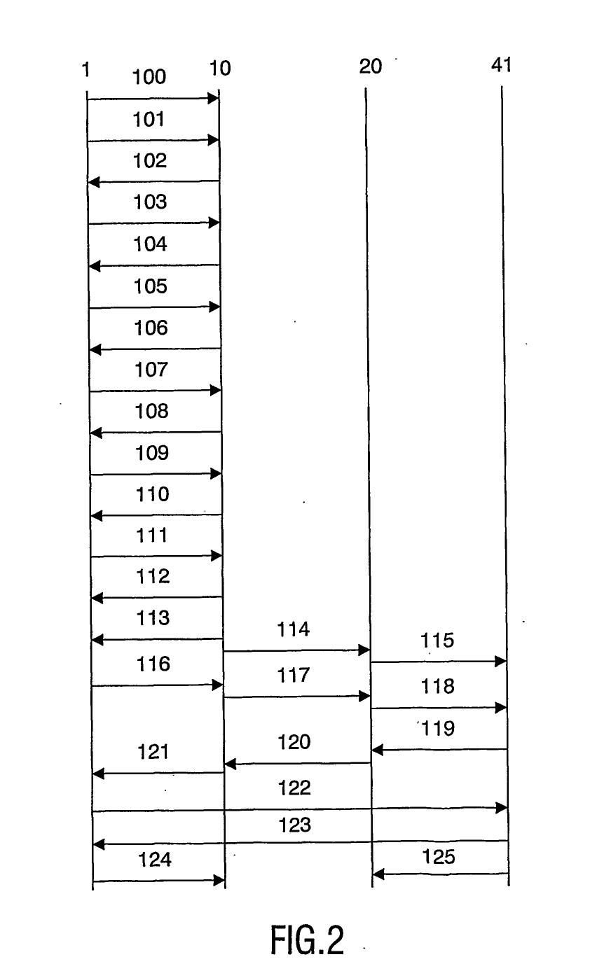

FIG. 2 illustrates a communication diagram elucidating a method according to the invention and one or more processor program products according to the invention.

The telecommunication system disclosed in FIG. 1 comprises a mobile terminal 1 comprising a controller 2 coupled to a transceiver 3,4,5 comprising a transmitter 3, an interface 4 and a receiver 5. Transmitter 3 is further coupled to interface 4, which is further coupled to an antenna and to receiver 5. Mobile terminal 1 further comprises a generator 6 coupled to controller 2 and to transmitter 3, and a detector 7 coupled to controller 2 and receiver 5.

The telecommunication system disclosed in FIG. 1 further comprises a network-unit 10 comprising a messaging server 11 comprising a controller 12, a memory 13 coupled to said controller 12, a detector 14 coupled to said controller 11 and a generator 15 coupled to said controller 12. Network-unit 10 further comprises a switch 10 coupled to controller 12 and to a transceiver 17,18,19 comprising a transmitter 19, an interface 18 and a receiver 17. Transmitter 19 is further coupled to interface 18, which is further coupled to an antenna and to receiver 17. Detector 14 and generator 15 are further coupled to switch 16.

Both antennas are coupled via a radio channel 8 based upon time division multiplexing and/or frequency division multiplexing and/or code division multiplexing etc.

The telecommunication system disclosed in FIG. 1 further comprises a bridging server 30 comprising a switch 31 coupled to a controller 32, which is further coupled to a generator 33 and to a detector 34. Generator 33 and detector 34 are further coupled to switch 31.

The telecommunication system disclosed in FIG. 1 further comprises a further network-unit 20 coupled to switch 16 and to switch 31, with switch 31 further being coupled to switch 16.

A user operating mobile terminal 1 and deciding that he/she wants to make a call or wants to be available for incoming calls switches mobile terminal 1 on, for example by pressing a key of a keyboard for example forming part of a man-machine-interface or mmi not shown and further comprising for example a display and being coupled to controller 2. In response, controller 2 controls generator 6 in such a way that a control instruction is generated in the form of a register instruction, which is supplied to transmitter 3. Transmitter 3 receives from controller 2 an identification of said user and/or of mobile terminal 1 (origin) and/or an identification of network-unit 10 and/or of messaging server 11 (destination), which identifications are for example stored in a memory not shown and coupled to controller 2. Said identification of said user and/or of mobile terminal 1 allows said user to use different terminals and/or allows more than one mobile terminal to use the same network-unit 10, and said identification of network-unit 10 and/or of messaging server 11 allows said user and/or mobile terminal 1 to enter the home network via another network-unit and/or another messaging server.

Transmitter 3 combines the register instruction and said identifications into a register message and transmits this register message via interface 4 and radio channel 8 to network-unit 10, which receives said register message via interface 18 at receiver 17. Receiver 17 supplies the register message to switch 16, which supplies (a part of) the register message (with or without one or more identifications) to detector 14. Detector 14 informs controller 12 that mobile terminal 1 wants to register at messaging server 11. Controller 12 instructs generator 15 to generate a response (register) instruction for confirming the receipt of said register message, which response (register) instruction, together with one or more of said identifications, is combined into a response (register) message, which is supplied via switch 16 to transmitter 19.

Transmitter 19 transmits this response (register) message via interface 18 and radio channel 8 to mobile terminal 1, which receives said response (register) message via interface 4 at receiver 5. Receiver 5 supplies the response (register) message to detector 7. Detector 7 detects one or more of said identifications and the response (register) instruction and informs controller 2 that messaging server 11 has received said register message. As a result, authentication is started.

Generator 6 will generate one or more authentication instructions, transmitter 3 will combine said one or more authentication instructions with said identifications into one or more authentication messages to be transmitted to messaging server 11 in network-unit 10, and in response one or more response (authentication) messages will be sent back. Finally at least one of said controllers 2 and 12 will decide that said authentication has been successful, and said authentication is finished, with the last response (authentication) message resulting in the word “welcome” being displayed on said display. Then, capabilities are exchanged.

Generator 6 will generate one or more capability instructions, transmitter 3 will combine said one or more capability instructions with said identifications into one or more capability messages to be transmitted to messaging server 11 in network-unit 10, and in response one or more response (capability) messages will be sent back. Said capability instructions define the kinds of interactions possible, like for example a GSM communication, a UMTS communication, a wireless LAN communication, an IP communication, a Voice over IP or VoIP communication, an MPEG-2 or MPEG-4 communication, voice mail, conference call etc. after which at least one of said parties will decide which communication will take place. Finally at least one of said controllers 2 and 12 will decide which capabilities are available between mobile terminal 1 and network-unit 10, and said exchange of capabilities is finished, with the last response (capability) message comprising for example an overview of possible capabilities to be used, which overview is displayed on said display, thereby offering said user to activate them.

In case said user operating mobile terminal 1 wants to make a call to a further user at a further terminal, he/she for example presses keys of the keyboard for example selecting a call menu and/or entering an identification of said further user and/or of the further terminal etc. In response, controller 2 controls generator 6 in such a way that a control instruction is generated in the form of a set up instruction, which is supplied to transmitter 3. Transmitter 3 receives from controller 2 the identification of said user and/or of mobile terminal 1 (origin) and the identification of said further user and/or of the further terminal (destination).

Transmitter 3 combines said set up instruction and said identifications into a set up message and transmits this set up message via interface 4 and radio channel 8 to network-unit 10, which receives said set up message via interface 18 at receiver 17. Receiver 17 supplies the set up message to switch 16, which supplies (a part of) the set up message (with or without one or more identifications) to detector 14. Detector 14 informs controller 12 that said user and/or mobile terminal 1 wants to set up a call with said further user and/or further terminal. Controller 12 consults memory 13 and finds out that one of the three following possibilities is going on.

According to a first possibility (also shown in FIG. 2 with both messaging servers in FIG. 2 then coinciding), said further user and/or said further terminal 51 (not shown detailledly but for example containing the same blocks as mobile terminal 1) are coupled directly to messaging server 11 via switch 16. Controller 12 consults memory 13, finds out about this and that said further user and/or said further terminal 51 are available and which capabilities both terminals 1,51 have in common, and instructs generator 15 to generate a forward (set up) instruction for forwarding the set up message, which forward (set up) instruction, together with the identification of the further user and/or of the further terminal 51 and with the identification of said user and/or of mobile terminal 1 is combined into a forward (set up) message, which is supplied via switch 16 to further terminal 51 (possible via another transceiver).

In further terminal 51, receiver 55 receives said forward (set up) message via interface 54, and supplies the forward (set up) message to detector 57. Detector 57 detects the identifications and the forward (set up) instruction and informs controller 52 that mobile terminal 1 wants to communicate. Controller 52 instructs generator 56 to generate a response (set up) instruction, which response (set up) instruction, together with the identification of the further user and/or of the further terminal 51 and with the identification of said user and/or of mobile terminal 1 is combined into a response (set up) message, which is supplied via transmitter 53 and switch 16 (possible via the other transceiver) to messaging server 11.

Messaging server 11 receives said response (set up) message via switch 16, with detector 14 detecting the identifications and the response (set up) instruction. Detector 14 informs controller 12 that said further user and/or further terminal 51 has responded, and instructs generator 15 to generate a forward response (set up) instruction for forwarding the response (set up) message, which forward response (set up) instruction, together with the identification of the further user and/or of the further terminal 51 and with the identification of said user and/or of mobile terminal 1 is combined into a forward response (set up) message, which is supplied via switch 16 to transmitter 19.

Transmitter 19 transmits this forward response (set up) message via interface 18 and radio channel 8 to mobile terminal 1, which receives said forward response (set up) message via interface 4 at receiver 5. Receiver 5 supplies the forward response (set up) message to detector 7. Detector 7 detects the identifications and the forward response (set up) instruction and informs controller 2 that messaging server 11 has received said response (set up) message from further terminal 51. Then, the call can be made from mobile terminal 1 to said further terminal 51 in accordance with capabilities negotiated before between mobile terminal 1 and network-unit 10 and between said further terminal 51 and network-unit 10.

In case of both terminals 1,51 being able to make a UMTS videocall (to be found out via both capability negotiations), either further terminal 51 or messaging server 11 will add a UMTS videocall address (UMTS telephone number) of said further terminal 51 to said (forward) response (set up) message. Mobile terminal 1 will receive and detect this UMTS videocall address and for example offer it to said user, who can then activate it. In case of both terminals 1,51 being able to make several kinds of communications (to be found out via both capability negotiations), either further terminal 51 or messaging server 11 will add one or more addresses (communication addresses like telephone numbers and/or IP-addresses and/or email addresses etc.) of said further terminal 51 to said (forward) response (set up) message. Mobile terminal 1 will receive and detect these addresses and for example offer them to said user, who can then select one of them and activate this one.

Generally, the call will not take place via messaging server 11. However, informational/control messages related to the call may be exchanged between one or more of said terminals and the messaging server. For example, every 10 seconds an informational message may be sent to one or more of said terminals with “total call time” information, or if the capabilities of for example further terminal 51 change during the call a control message with a “switch from video to voice call” instruction could be sent to mobile terminal 1. As soon as said call is finished, messages will be exchanged to inform messaging server 11.

According to a second possibility (also shown in FIG. 2 with both messaging servers in FIG. 2 then being different), said further user and/or said further terminal 41 (not shown detailledly but for example containing the same blocks as mobile terminal 1) are coupled to further network-unit 20 (not shown detailledly but for example containing the same blocks as network-unit 10) comprising a further messaging server 21. Controller 12 consults memory 13, finds out about this, and instructs generator 15 to generate a forward (set up) instruction for forwarding the set up message, which forward (set up) instruction, together with the identification of the further user and/or of the further terminal 41 and with the identification of said user and/or of mobile terminal 1 is combined into a forward (set up) message, which is supplied via switch 16 to switch 26 in network-unit 20. Switch 26 supplies (a part of) the forward (set up) message (with or without one or more identifications) to detector 24. Detector 24 informs controller 22 that said user and/or mobile terminal 1 wants to set up a call with said further user and/or further terminal 41. Controller 22 instructs generator 25 to generate a further forward (set up) instruction for further forwarding the forward (set up) message, which further forward (set up) instruction, together with the identification of the further user and/or of the further terminal 41 and with the identification of said user and/or of mobile terminal 1 is combined into a further forward (set up) message, which is supplied via switch 16 to further terminal 41 (possible via transceiver 27,28,29).

In further terminal 41, receiver 45 receives said further forward (set up) message via interface 44, and supplies the further forward (set up) message to detector 47. Detector 47 detects the identifications and the further forward (set up) instruction and informs controller 42 that mobile terminal 1 wants to communicate. Controller 42 instructs generator 46 to generate a response (set up) instruction, which response (set up) instruction, together with the identification of the further user and/or of the further terminal 41 and with the identification of said user and/or of mobile terminal 1 is combined into a response (set up) message, which is supplied via transmitter 43 and switch 26 (possible via transceiver 27,28,29) and switch 16 to messaging server 11.

Messaging server 11 receives said response (set up) message via switch 16, with detector 14 detecting the identifications and the response (set up) instruction. Detector 14 informs controller 12 that said further user and/or further terminal 41 has responded, and instructs generator 15 to generate a forward response (set up) instruction for forwarding the response (set up) message, which forward response (set up) instruction, together with the identification of the further user and/or of the further terminal 41 and with the identification of said user and/or of mobile terminal 1 is combined into a forward response (set up) message, which is supplied via switch 16 to transmitter 19.

Transmitter 19 transmits this forward response (set up) message via interface 18 and radio channel 8 to mobile terminal 1, which receives said forward response (set up) message via interface 4 at receiver 5. Receiver 5 supplies the forward response (set up) message to detector 7. Detector 7 detects the identifications and the forward response (set up) instruction and informs controller 2 that messaging server 11 has received said response (set up) message from further terminal 41. Then, the call can be made from mobile terminal 1 to said further terminal 41 in accordance with capabilities negotiated before between mobile terminal 1 and network-unit 10 and between said further terminal 41 and network-unit 20.

In case of terminal 1 being able to make a UMTS videocall (to be found out via the capability negotiation) and in case both terminals 1,41 being able to make a GSM call (to be found out via both capability negotiations), either further terminal 41 or messaging server 21 or messaging server 11 will add a GSM address (GSM telephone number) of said further terminal 41 to said (forward) response (set up) message. Mobile terminal 1 will receive and detect this GSM address and for example inform said user that a UMTS videocall cannot be made and offer said GSM address to said user, who can then activate it.

Generally, the call will not take place via the messaging servers 11 and 21. However, informational/control messages related to the call may be exchanged between one or more of said terminals and one or more of said messaging servers. For example, every 10 seconds an informational message may be sent to one or more of said terminals with “total call time” information, or if the capabilities of for example further terminal 41 change during the call a control message with a “switch from video to voice call” instruction could be sent to mobile terminal 1. As soon as said call is finished, messages will be exchanged to inform the messaging servers 11 and 21.

According to a third possibility (also shown in FIG. 2 with communication between messaging server C and user D in FIG. 2 then being in a different and/or non-standard protocol), said further user and/or said further terminal are coupled to bridging server 30 due to not being equipped to (first option) use a messaging infrastructure at all or to (second option) use a different (non-compatible) messaging infrastructure. Controller 12 consults memory 13, finds out about this, and instructs generator 15 to generate a forward (set up) instruction for forwarding the set up message, which forward (set up) instruction, together with the identification of the further user and/or of the further terminal and with the identification of said user and/or of mobile terminal 1 is combined into a forward (set up) message, which is supplied via switch 16 to switch 31 in bridging server 30. Switch 31 supplies (a part of) the forward (set up) message (with or without one or more identifications) to detector 34. Detector 34 informs controller 32 that said user and/or mobile terminal 1 wants to set up a call with said further user and/or further terminal. In case of said second option, controller 32 instructs generator 33 to generate a message instruction in a format/protocol to be understood by said further terminal, which is supplied via switch 31 to the further user and/or to the further terminal, via a non-compatible messaging infrastructure and/or for example via an ISDN or analog telephone call.

Said further user and/or further terminal react to that, and as a result, detector 34 will detect a reaction arriving via switch 31. In response, controller 32 instructs generator 33 to generate a response (set up) instruction, which response (set up) instruction, together with the identification of the further user and/or of the further terminal and with the identification of said user and/or of mobile terminal 1 is combined into a response (set up) message, which is supplied via switches 31 and 16 to messaging server 11. In case of said first option, said response (set up) instruction is generated without any action from said further user and/or further terminal.

Messaging server 11 receives said response (set up) message via switch 16, with detector 14 detecting the identifications and the response (set up) instruction. Detector 14 informs controller 12 that said further user and/or further terminal has responded, and instructs generator 15 to generate a forward response (set up) instruction for forwarding the response (set up) message, which forward response (set up) instruction, together with the identification of the further user and/or of the further terminal and with the identification of said user and/or of mobile terminal 1 is combined into a forward response (set up) message, which is supplied via switch 16 to transmitter 19.

Transmitter 19 transmits this forward response (set up) message via interface 18 and radio channel 8 to mobile terminal 1, which receives said forward response (set up) message via interface 4 at receiver 5. Receiver 5 supplies the forward response (set up) message to detector 7. Detector 7 detects the identifications and the forward response (set up) instruction and informs controller 2 that messaging server 11 has received said response (set up) message from bridging server 30. Then, the call can be made from mobile terminal 1 to said further terminal in accordance with capabilities negotiated before between mobile terminal 1 and network-unit 10 and in accordance with capabilities of said further terminal.

In case of terminal 1 being able to make a UMTS videocall and a GSM call (to be found out via the capability negotiation) and in case of said further terminal just being able to make an analog or ISDN call (this is known in bridging server 30), either bridging server 30 or messaging server 11 will add an analog or ISDN address (analog or ISDN telephone number) of said further terminal to said (forward) response (set up) message. Mobile terminal 1 will receive and detect this analog or ISDN address and for example inform said user that a UMTS videocall or a GSM call cannot be made and offer said analog or ISDN address to said user, who can then make a call from his mobile terminal to the analog or ISDN network.

Generally, the call will not take place via messaging server 11. However, informational/control messages related to the call may be exchanged between mobile terminal 1 and the messaging server 11. For example, every 10 seconds an informational message may be sent to mobile terminal 1 with “total call time” information, or if certain capabilities change during the call a control message with a “switch from video to voice call” instruction could be sent to mobile terminal 1. As soon as said call is finished, messages will be exchanged to inform messaging server 11. Whether bridging server 30 (read: switch 31) is involved in this call, depends upon the analog/ISDN network between switch 31 and said further terminal and upon the way the GSM network is connected to this analog/ISDN network.

Summarizing said possibilities, a user may interact with a messaging server via all kinds of terminals and all kinds of links and all kinds of network-units, for registration, authentication, capability negotiation, getting information etc., for setting up communications with other users via all kinds of terminals and all kinds of links and all kinds of network-units independently of said other users using the same messaging infrastructure via one or more messaging servers or using a different one or no one at all with a bridging server then being a kind of interface.

About implementation the following: Said generators are for example table memories comprising columns for in response to an input signal corresponding with a left column signal generating an output signal corresponding with a right column signal at the same row, or are for example converters etc. Said detectors are for example comparators for comparing an input signal with reference signals, or are for example processors for performing a function on an input signal etc. In other words, a generator may have a list of ‘template XML messages’ which on receipt from an input signal selects the correct template message, fills in the relevant fields, and sends this XML as an output signal, and a detector may parse the input XML signal, and pull out the relevant fields, etc. Said controllers are for example processors comprising a Random Access Memory or a Read Only Memory or a hard disk etc. Said bridging server will usually comprise a messaging server (controller+detector+generator+memory) and either multifunctional detectors and generators or two pairs of detectors and generators, a pair for each different messaging infrastructure. Said combining of instructions and identifications could for example be done via shift registers. So, each block can be 100% hardware, but can also be 100% software, or a combination of both.

Said switch in said network-unit may be located as shown in FIG. 1, but may also located at the other side of the messaging server, with the messaging server then being located between sender-receiver-interface and switch. Alternatively, said switch may comprise said messaging server or vice versa.

Roaming can be dealt with easily by checking in each network-unit whether this network-unit is the home network-unit (home messaging server) or not and then sending each message to the home network-unit (thereby billing the client with a small charge at the hand of his/her identification for example per message). Of course, services could also be delivered locally (thereby billing the client with a higher charge at the hand of his/her identification for example per message).

When sending a message to the network-unit and receiving a response message, this response message or a further response message further/also in addition/alternatively may comprise (presence) information about other users being available (turned on or on-line) and may comprise an address book and may comprise status information and may comprise cost information etc. Even during a call, when the messaging server is not involved in the call itself, one or more messages described above may be exchanged.

In FIG. 2 the numbers in the communication diagram have the following meaning (with 1 being mobile terminal 1 operated by user A, with 10 being network-unit 10 comprising messaging server B, with 20 being network-unit 20 comprising messaging server C and with 41 being further terminal 41 operated by user D):
100: Open connection to server (like for example open poort 5222)
101: Send request for messaging communication
102: Response from server: OK
103: Authentication message to server
104: Authentication response
105: Authentication confirmation to server
106: Authentication confirmation to client
107: Request server capabilities
108: Response server capabilities
109: Request address book
110: Response address book
111: Set user A@B on client's presence to be on-line
112: Receive presence information from all people in presence's book
(113: Receive presence information from D@C if not already received before at 112)
114: Send user A@B on client's presence to remote server
115: Send user A@B on client's presence to remote user D@C
116: Call to D@C
117: Call to D@C from user A@B
118: Receive call from A@B
119: Accept call from A@B
120: Accept call to D@C from A@B
121: Accept call to D@C
122: Voice connection
123: Voice connection
124: Set status: in call
125: Set status: in call
   Each number 100-125 can correspond with (a part of) one or several messages. Numbers 100-102 comprise register steps/functions, numbers 103-106 comprise authentication steps/functions, numbers 107-115 comprise information steps/functions with numbers 107-108 for example indicating a start and with numbers 109-110 for example indicating an exchange of server capabilities and with numbers 112-115 for example indicating an exchange of an address book and status updating, numbers 116-121 comprise set up steps/functions, numbers 122-123 comprise calling steps/functions, and numbers 124-125 comprise information steps/functions like for example status updating. Said steps and functions can be added to the steps and functions of methods and processor program products according to the invention, with further steps and functions not to be excluded.

1. Telecommunication system comprising a terminal and a network-unit, which terminal comprises a transceiver for transceiving messages and which network-unit comprises a transceiver for transceiving said messages and comprises a messaging server for serving said messages, characterized in that at least one message comprises at least a part of at least one control instruction for controlling at least one interaction between terminal and network-unit, with said terminal and said messaging server each comprising a detector for detecting control instructions and a generator for generating control instructions.

2. Telecommunication system according to claim 1, characterized in that said message further comprises an origin identification and/or a destination identification.

3. Telecommunication system according to claim 2, characterized in that control instructions comprise authentication instructions for authenticating said interaction.

4. Telecommunication system according to claim 2, characterized in that control instructions comprise capability instructions defining capabilities.

5. Telecommunication system according to claim 2, characterized in that a control instruction comprises a set up instruction for setting up a communication.

6. Telecommunication system according to claim 3, characterized in that said messages are XML messages.

7. Terminal for use in a telecommunication system comprising said terminal and a network-unit, which terminal comprises a transceiver for transceiving messages and which network-unit comprises a transceiver for transceiving said messages and comprises a messaging server for serving said messages, characterized in that at least one message comprises at least a part of at least one control instruction for controlling at least one interaction between terminal and network-unit, with said terminal and said messaging server each comprising a detector for detecting control instructions and a generator for generating control instructions.

8. Network-unit for use in a telecommunication system comprising a terminal and said network-unit, which terminal comprises a transceiver for transceiving messages and which network-unit comprises a transceiver for transceiving said messages and comprises a messaging server for serving said messages, characterized in that at least one message comprises at least a part of at least one control instruction for controlling at least one interaction between terminal and network-unit, with said terminal and said messaging server each comprising a detector for detecting control instructions and a generator for generating control instructions.

9. Messaging server for use in a telecommunication system comprising a terminal and a network-unit, which terminal comprises a transceiver for transceiving messages and which network-unit comprises a transceiver for transceiving said messages and comprises said messaging server for serving said messages, characterized in that at least one message comprises at least a part of at least one control instruction for controlling at least one interaction between terminal and network-unit, with said terminal and said messaging server each comprising a detector for detecting control instructions and a generator for generating control instructions.

10. Method for use in a telecommunication system and comprising the steps of transceiving messages in a terminal and of transceiving said messages in a network-unit and of serving said messages in a messaging server in said network-unit, characterized in that at least one message comprises at least a part of at least one control instruction for controlling at least one interaction between terminal and network-unit, with said method comprising the steps of detecting control instructions in said terminal and in said messaging server and of generating control instructions in said terminal and in said messaging server.

11. Processor program product for use in a network-unit and comprising the function of transceiving messages in said network-unit and of serving said messages in a messaging server in said network-unit, characterized in that at least one message comprises at least a part of at least one control instruction for controlling at least one interaction between terminal and network-unit, with said processor program product comprising the functions of steps of detecting control instructions in said messaging server and of generating control instructions in said messaging server.

12. Processor program product for use in a terminal and comprising the function of transceiving messages in said terminal, characterized in that at least one message comprises at least a part of at least one control instruction for controlling at least one interaction between terminal and network-unit, with said processor program product comprising the functions of detecting control instructions in said terminal and of generating control instructions in said terminal.
